(19) United States
(12) Patent Application Publication
(10) Pub. No.: US 2017/0108640 A1
(43) Pub. Date: Apr. 20, 2017

(54) BACKLIGHT MODULE AND DISPLAY DEVICE

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Jie ZENG, Shenzhen, Guangdong (CN); Gege ZHOU, Shenzhen, Guangdong (CN)

(73) Assignees: Shenzhen China Star Optoelectronics Technology Co., Ltd., Shenzhen, Guangdong (CN); Wuhan China Star Optoelectronics Technology Co., Ltd., Wuhan, Hubei (CN)

(21) Appl. No.: 14/905,816

(22) PCT Filed: Apr. 10, 2015
(86) PCT No.: PCT/CN2015/076289

§ 371 Date: Jan. 17, 2016

(30) Foreign Application Priority Data
Mar. 20, 2015 (CN) 201510125058.3

(51) Int. Cl. F21V 8/00

(52) U.S. Cl. CPC G02B 6/0088; G02B 6/0055

(57) ABSTRACT

The present invention proposes a back light module. The backlight module includes a back plate, a light guiding plate, and an optical film. The back plate includes a bottom plate and a side plate positioned on the bottom plate. The side plate has a concave part on the inner surface. The light guiding plate and the optical film are positioned within the light guiding plate. A non-light-inputting side of the light guiding plate is inserted into the concave part of the side plate, and the side plate is arranged to surround the light guiding plate and the optical film. The present invention also proposes a display device.

### CROSS REFERENCE

This application claims the priority of Chinese Patent Application No. 201510125058.3, entitled “Backlight module and display device”, filed on Mar. 20, 2015, the disclosure of which is incorporated herein by reference in its entirety.

### FIELD OF THE INVENTION

The present invention relates to a liquid crystal display technology field, and more particularly to a backlight module and a display device.

### BACKGROUND OF THE INVENTION

Liquid crystal display (LCD) is widely used in all kinds of electronic devices for displaying images. Because the electronic devices need to be lighter and thinner, side frames of the electronic devices become thinner. As an important component of the electronic device, the side frame of LCD needs to be thinner as well.

A conventional backlight module comprises a plastic frame. The light guiding plate is surrounded by the plastic frame. The optical films are fixed on the guiding light, the plastic frame and a back plate through using a transparent tape. However, because there is a space between a side wall of the back plate and the light guiding plate and the back plate has a wide width, a long double-sided tape is required to fix the optical films on the back plate and the light guiding plate. This structure increases the entire width of the non-viewable side frame.

### SUMMARY OF THE INVENTION

One objective of the present disclosure is to provide a backlight module capable of reducing its occupying space and reduce a width of a side frame.

The present invention also proposes a display device.

According to an exemplary embodiment, this is provided a backlight module including a back plate, a light guiding plate and an optical film. The back plate includes a bottom plate and a side plate positioned on the bottom plate. The inner surface of the side plate has a concave part. The light guiding plate and the optical film are installed inside the back plate. The side plate is arranged to surround the light guiding plate and the optical film. A non-light-inputting ends of the light guiding plate is inserted into the concave part. The optical film is positioned on the light guiding plate.

In addition, an upper surface of the side plate and an upper surface of the optical film correspond to the same horizontal plane, and the optical film is fixed with the upper surface of the side plate by a double-sided tape.

In addition, the backlight module further includes a reflector, positioned between the light guiding plate and the back plate.

In addition, an inner surface of the concave part has a reflection layer, and the reflection layer contacts the light guiding plate.

In addition, a supporting end is formed at an end of the concave part to support the double-sided tape such that the light guiding plate is positioned.

According to an exemplary embodiment, this is provided a display device including a backlight module and a display panel. The backlight module includes a back plate, a light guiding plate, and an optical film. The back plate includes a bottom plate and a side plate positioned on the bottom plate. The side plate has a concave part on the inner surface. The light guiding plate and the optical film are positioned within the light guiding plate. A non-light-inputting side of the light guiding plate is inserted into the concave part of the side plate, and the side plate is arranged to surround the light guiding plate and the optical film. The display panel is positioned on the backlight module and the display panel is fixed with the optical film by a double-sided tape.

In addition, an upper surface of the side plate and an upper surface of the optical film correspond to a same horizontal plane, and the optical film is fixed with the upper surface of the side plate by a double-sided tape.

In addition, the backlight module further comprises a reflector which is positioned between the light guiding plate and the back plate.

In addition, an inner surface of the concave part has a reflection layer, and the reflection layer contacts the light guiding plate.

In addition, the display device further comprises a side frame, capable of being inserted into the concave part.

In addition, a supporting end is formed at an end of the concave part to support the double-sided tape such that the light guiding plate is positioned.

In addition, the display panel has a display area and a side frame area surrounding the display area, and the side frame area is fixed on the back plate by a double-sided tape.

The backlight module according to an exemplary embodiment has a concave part in the side plate of the back plate. A non-light-inputting side of the light guiding plate can be inserted into the concave part and thus is directly fixed by the side plate. Therefore, the back plate can reduce its occupying space and a plastic frame is not necessary. This structure reduces the width of the side frame of the backlight module and further raises the viewable area of the display device.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a diagram showing a cross-sectional view of a backlight module according to an exemplary embodiment of the present disclosure.

FIG. 2 is diagram showing a cross-sectional view of a back plate of the backlight module shown in FIG. 1.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

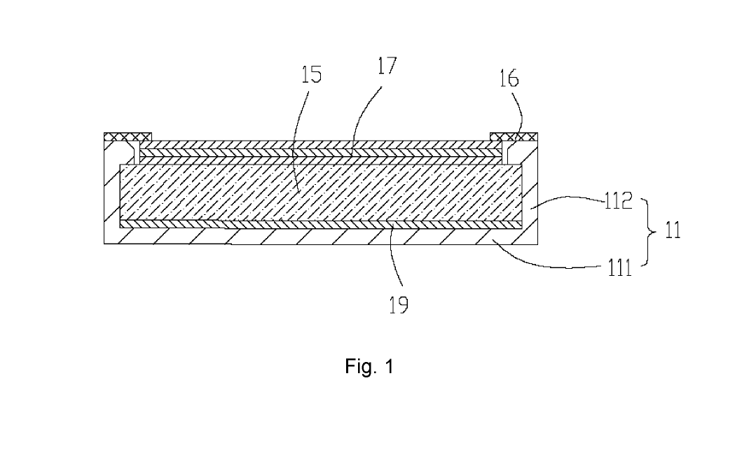

Please refer to FIG. 1. A backlight module is provided. The backlight module comprises a back plate 11, a light guiding plate 14, and optical films 17. The light guiding plate 15 and the optical films are sequentially installed into the back plate 11. Each of the light guiding plate 15 and the optical films 17 has a shape of a plate. The light guiding plate 15 has an incident side and three non-light-inputting sides.

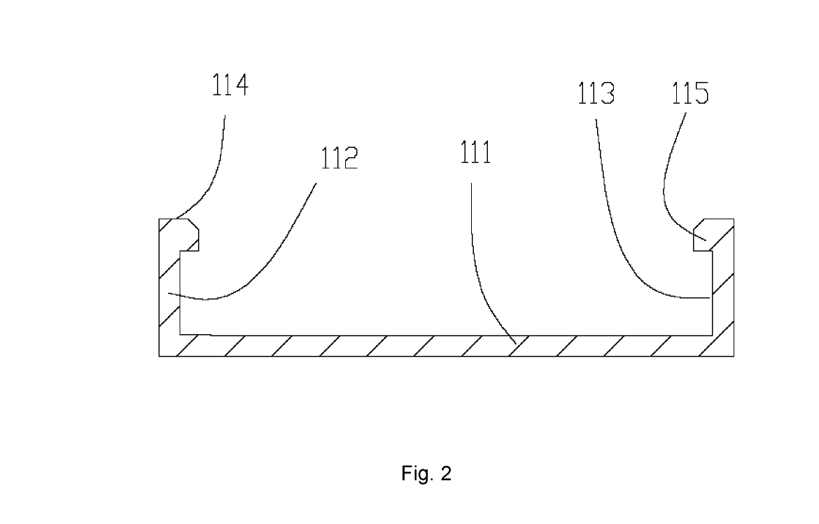

Please refer to FIG. 2. The back plate 11 comprises a bottom plate 111 and a side plate 112 positioned on the bottom plate 111. The bottom plate 111 and the side plate 112 forms a positioning space for positioning the light guiding plate 15 and the optical films 17. The backlight module further comprises a reflector 19, having a shape of a sheet, positioned between the bottom plate 111 and the light guiding plate 15.

The side plate 112 has a concave part on the inner surface of the side plate 112. The light guiding plate 15 and the optical films 17 are installed inside the back plate 11. The side frame 112 is arranged to surround the light guiding plate 15 and the optical films 17. The non-incident sides of the light guiding plate 15 are inserted into the concave port 113 and the optical films 17 are positioned on the light guiding plate 15. The concave part 113 is used to fix the light guiding plate 15 such that the plastic frame is not necessary. This structure saves the occupying space of the entire back plate and thus reduces the size of the back plate. The concave part 113 is an open concave groove, which has a rectangular shape. In addition, the concave part 113 extends to the bottom plate 111 such that a supporting end 115 is formed on an end of the side plate 112. The supporting end 115 may be use to push the light guiding plate 15 to fix the light guiding plate 15 and support the double-sided tape to fix the optical films 17. In another embodiment, the concave can be a concave groove having a shape of a stripe, which forms along the side plate 112.

In addition, the upper surface 114 of the back plate 11 and the upper surface of the optical films 17 are corresponding to the same horizontal plane. The optical films 17 are fixed with the upper surface 114 of the back plate by the double-sided tapes 16 such that the positioning of the optical films is achieved.

Furthermore, the inner surface of the concave part 113 has a reflection layer (not shown). The reflection layer contacts the non-light-inputting sides of the light guiding plate 15. The reflection layer can be spread on the inner surface.

In another embodiment, the reflection layer can be formed by an extension part of the reflector 19, which extends to the concave part 113.

Furthermore, the present disclosure further provides a display device. The display device includes the aforementioned backlight module and a display panel. The optical films 17 are positioned on the light guiding plate 15. The display panel is positioned on the backlight module and the display module is fixed with the optical films 17 by a double-sided tape.

In addition, the display device further includes a side frame (not shown). The side frame can be inserted into the concave part. The display device further includes a light source, which is positioned on the incident side of the light guiding plate.

The backlight module according to an exemplary embodiment has a concave part on the side plate of the back plate to fix the light guiding plate. This structure reduces the occupying space of the back plate. In addition, the plastic frame is not required because the light guiding plate can be fixed by the side plate. Therefore, this structure reduces the width of the non-viewable side frame of the backlight module and also raises the viewable portion of the display device.

Above are embodiments of the present invention, which does not limit the scope of the present invention. Any modifications, equivalent replacements or improvements within the spirit and principles of the embodiment described above should be covered by the protected scope of the invention.

What is claimed is:

1. A backlight module comprising:
a back plate, comprising:
a bottom plate; and
a side plate, positioned on the bottom plate, the side plate having a concave part on the inner surface;
a light guiding plate, positioned within the back plate;
an optical film, positioned on the light guiding plate;
wherein a non-light-inputting side of the light guiding plate is inserted into the concave part of the side plate, and the side plate is arranged to surround the light guiding plate and the optical film.

2. The backlight module of claim 1, wherein an upper surface of the side plate and an upper surface of the optical film correspond to a same horizontal plane, and the optical film is fixed with the upper surface of the side plate by a double-sided tape.

3. The backlight module of claim 1, further comprising:
a reflector, positioned between the light guiding plate and the back plate.

4. The backlight module of claim 1, wherein an inner surface of the concave part has a reflection layer, and the reflection layer contacts the light guiding plate.

5. The backlight module of claim 2, wherein a supporting end is formed at an end of the concave part to support the double-sided tape such that the light guiding plate is positioned.

6. A display device comprising a backlight module and a display panel, the backlight module comprising:
a back plate, comprising:
a bottom plate; and
a side plate, positioned on the bottom plate, the side plate having a concave part on the inner surface;
a light guiding plate, positioned within the back plate;
an optical film, positioned within the back plate;
wherein a non-light-inputting side of the light guiding plate is inserted into the concave part of the side plate, and the side plate is arranged to surround the light guiding plate and the optical film, and
wherein the display panel is positioned on the backlight module and the display panel is fixed with the optical film by a double-sided tape.

7. The display device of claim 6, wherein an upper surface of the side plate and an upper surface of the optical film correspond to a same horizontal plane, and the optical film is fixed with the upper surface of the side plate by a double-sided tape.

8. The display device of claim 7, wherein the backlight module further comprises a reflector which is positioned between the light guiding plate and the back plate.

9. The display device of claim 7, wherein an inner surface of the concave part has a reflection layer, and the reflection layer contacts the light guiding plate.

10. The display device of claim 6, further comprising:
a side frame, capable of being inserted into the concave part.

11. The display device of claim 7, wherein a supporting end is formed at an end of the concave part to support the double-sided tape such that the light guiding plate is positioned.

12. The display device of claim 11, wherein the display panel has a display area and a side frame area surrounding the display area, and the side frame area is fixed on the back plate by a double-sided tape.
